(19) United States
(12) Patent Application Publication
(10) Pub. No.: US 2024/0319652 A1
(43) Pub. Date: Sep. 26, 2024

(54) IMAGE FORMING APPARATUS

(71) Applicant: FUJIFILM Business Innovation Corp., Tokyo (JP)

(72) Inventor: Yoshiyuki TOMINAGA, Kanagawa (JP)

(73) Assignee: FUJIFILM Business Innovation Corp., Tokyo (JP)

(21) Appl. No.: 18/355,383

(22) Filed: Jul. 19, 2023

(30) Foreign Application Priority Data
Mar. 24, 2023 (JP) 2023-048950

(51) Int. Cl. G03G 15/00; G03G 15/01; G03G 21/18

(52) U.S. Cl. CPC G03G 15/6591; G03G 15/0189; G03G 15/6597; G03G 21/1821

(57) ABSTRACT

An image forming apparatus includes a transfer unit that comes into contact with a target object and that transfers an image to the target object, a holding portion that holds the target object including a circumferential surface such that the circumferential surface rotates along a transfer direction of the transfer unit, and a transport unit that transports the target object held by the holding portion along a transport route, that stops transportation of the target object in a case where the transfer unit transfers the image to the target object, and that causes the target object to be separated from the transfer unit before a surface of the target object on which transfer of the image is finished comes into contact with the transfer unit again.

### CROSS-REFERENCE TO RELATED APPLICATIONS

This application is based on and claims priority under 35 USC 119 from Japanese Patent Application No. 2023-048950 filed Mar. 24, 2023.

### BACKGROUND

### (i) Technical Field

The present invention relates to an image forming apparatus.

### (ii) Related Art

In recent years, there is a case where an image is printed on mediums having various thicknesses and shapes, the various mediums being formed of metal, glass, or a tile.

Disclosed in JP3292954B is a printing apparatus in which a disc is placed on a transportation table and an image is formed on the disc while the disc is being transported together with the transportation table.

### SUMMARY

In a case where a printing method in which an image is transferred with a transfer unit being in contact with a target object is used and an image is transferred to a circumferential surface while a cylinder or a sphere is being rotated, distortion of an image that has been transferred already occurs in a case where a portion to which the image has been transferred already comes into contact with the transfer unit again due to rotation of a medium.

Aspects of non-limiting embodiments of the present disclosure relate to an image forming apparatus that suppresses a decrease in image quality that is caused in a case where a printing method in which an image is transferred with a transfer unit being in contact with a target object is used, an image is transferred while a medium is being rotated, and a portion of the medium to which the image has been transferred comes into contact with the transfer unit again.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present invention, there is provided an image forming apparatus including
a transfer unit that comes into contact with a target object and that transfers an image to the target object,
a holding portion that holds the target object including a circumferential surface such that the circumferential surface rotates along a transfer direction of the transfer unit, and
a transport unit that transports the target object held by the holding portion along a transport route, that stops transportation of the target object in a case where the transfer unit transfers the image to the target object, and that causes the target object to be separated from the transfer unit before a surface of the target object on which transfer of the image is finished comes into contact with the transfer unit again.

### BRIEF DESCRIPTION OF THE DRAWINGS

Exemplary embodiment(s) of the present invention will be described in detail based on the following figures, wherein:

FIG. 1 is a view showing a configuration of an image forming apparatus to which the present exemplary embodiment is applied;

FIG. 2 is a view showing a configuration of a transfer unit;

FIGS. 3A to 3C are views showing an operation of a transport mechanism before image formation performed by the transfer unit is started, FIG. 3A is a view showing a state where height control is performed, FIG. 3B is a view showing a state where the transport mechanism has been withdrawn to a preparation position after the height control, and FIG. 3C is a view showing a state where transfer of an image is started by the transfer unit;

FIGS. 4A to 4C are views showing a method of transferring an image to a medium including a circumferential surface, FIG. 4A is a view showing a state at the start of transfer, FIG. 4B is a view showing a state during the transfer, and FIG. 4C is a view showing a state at the end of the transfer;

FIGS. 5A and 5B are views showing a configuration example of a jig that rotatably holds the medium, FIG. 5A is a view of the jig and the medium as seen in a direction parallel to a rotation axis of the medium, and FIG. 5B is a view of the jig and the medium as seen in a direction perpendicular to the rotation axis of the medium;

FIGS. 6A to 6C are views showing an example of a transfer position, FIG. 6A is a view showing a state where the transfer position is set upstream of a lowermost end of an intermediate transfer belt, FIG. 6B is a view showing a state where the transfer position is set at the lowermost end of the intermediate transfer belt, and FIG. 6C is a view showing a state where the transfer position is set downstream of the lowermost end of the intermediate transfer belt;

FIGS. 7A to 7C are views showing an example of a height adjustment method for the medium, FIG. 7A is a view showing a state where the medium is in contact with the lowermost end of the intermediate transfer belt while being positioned upstream of the lowermost end, FIG. 7B is a view showing a state where the medium is in contact with the lowermost end of the intermediate transfer belt, and FIG. 7C is a view showing a state where the medium is in contact with the lowermost end of the intermediate transfer belt while being positioned downstream of the lowermost end;

FIG. 8 is a view showing an example in which the medium and the intermediate transfer belt are restrained from coming into contact with each other again by means of a transport direction; and

FIGS. 9A and 9B are views showing an example in which a lifting and lowering unit restrains the intermediate transfer belt and the medium from coming into contact with each other again, FIG. 9A is a view showing a state where the intermediate transfer belt and the medium are in contact with each other, and FIG. 9B is a view showing a state where the intermediate transfer belt and the medium are separated from each other.

### DETAILED DESCRIPTION

Hereinafter, an exemplary embodiment of the present invention will be described in detail with reference to the accompanying drawings. An image forming apparatus of the present exemplary embodiment is an image forming apparatus for digital printing. Although examples of a printing method for digital printing include an electrophotographic printing method and an ink jet printing method, the present exemplary embodiment is based on the assumption that the electrophotographic printing method is used. In the case of the electrophotographic printing method, a transfer unit and a medium come into contact with each other in a case where an image is transferred to the medium. In addition, the present exemplary embodiment is based on the assumption that printing is performed on mediums having various thicknesses and shapes, the various mediums being formed of metal, glass, or a tile.

### Configuration of Apparatus

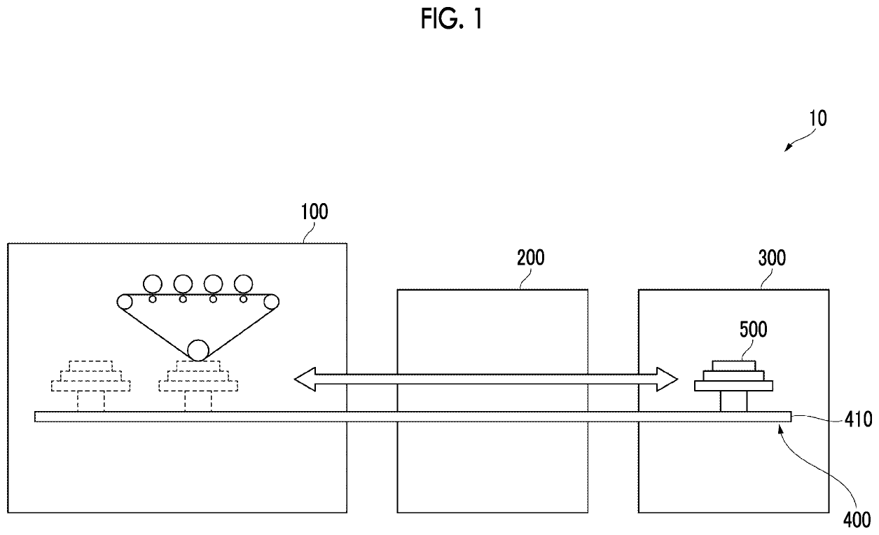

FIG. 1 is a view showing a configuration of an image forming apparatus to which the present exemplary embodiment is applied. An image forming apparatus 10 includes a transfer unit 100, a fixation unit 200, a medium attachment and detachment unit 300, and a transport mechanism 400. In addition, although not particularly shown in the drawings, the image forming apparatus 10 includes a control unit that includes one or a plurality of processors which are means for arithmetic operations, a memory serving as a work area in data processing, a storage device that holds a program or data, and the like. The control unit may be a single control unit that controls the operation of the entire image forming apparatus 10, or may be provided for each of the transfer unit 100, the fixation unit 200, the transport mechanism 400, and the like.

The transfer unit 100 is a unit that transfers, to a medium 500 that is a transfer target object, an image formed by toner particles or the like. The fixation unit 200 is a unit that heats the medium 500 so that the image transferred by the transfer unit 100 is fixed to a surface of the medium 500. The medium attachment and detachment unit 300 is a unit at which a user of the image forming apparatus 10 attaches the medium 500 to an attachment table (which will be described later) provided at the transport mechanism 400. The transport mechanism 400 is provided over all of the transfer unit 100, the fixation unit 200, and the medium attachment and detachment unit 300 and transports the medium 500, on which printing is performed, to each of the transfer unit 100, the fixation unit 200, and the medium attachment and detachment unit 300 as represented by an arrow in FIG. 1.

The medium attachment and detachment unit 300 is a housing of which a portion is provided with an opening through which the medium 500 can enter and exit the housing. One end-side portion of a transport rail 410 constituting the transport mechanism 400 is in the medium attachment and detachment unit 300 and a transport start position and a transport end position are set in the medium attachment and detachment unit 300. In the case of the image forming apparatus 10 shown in FIG. 1, the transport start position and the transport end position are set to the same place. In an initial stage, an attachment table 420 that constitutes the transport mechanism 400 is disposed at a place on the transport rail 410 that is set as the transport start position and the transport end position. In a case where the user inserts the medium 500 through the opening of the housing of the medium attachment and detachment unit 300 and places the medium 500 on the attachment table 420, the medium 500 can be transported by the transport mechanism 400. The medium 500 may be fixed to the attachment table 420 by means of a jig or the like holding the medium 500 in a case where the medium 500 is placed on the attachment table 420. After the image is transferred to the medium 500 by the transfer unit 100 and a fixation process is performed by the fixation unit 200, the attachment table 420 with the medium 500 placed thereon moves along the transport rail 410 and reaches the transport end position. In such a state, the user removes a jig (which will be described later) holding the medium 500 from the attachment table 420 and extracts the jig through the opening of the housing of the medium attachment and detachment unit 300.

### Configuration of Transfer Unit 100

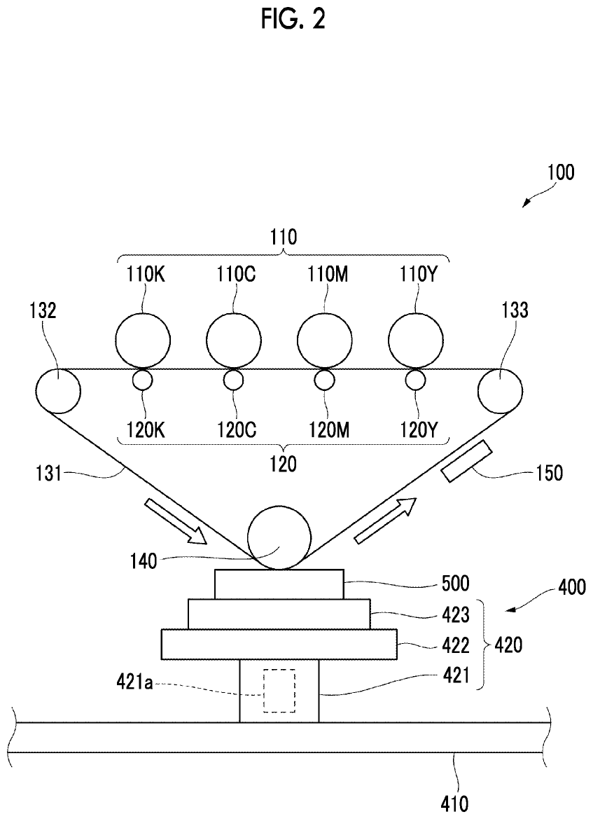

FIG. 2 is a view showing a configuration of the transfer unit 100. The transfer unit 100 forms an image by means of charged particles and generates an electric field to transfer an image to the medium 500. The transfer unit 100 includes development devices 110, primary transfer rolls 120, and an intermediate transfer belt 131. The intermediate transfer belt 131 is stretched, by rollers 132 and 133 and a backup roll 140, between the development devices 110 and a position at which transfer to the medium 500 is performed. In addition, the transfer unit 100 includes a cleaning device 150 removing particles adhering to the intermediate transfer belt 131.

The development devices 110 are units each of which forms, on a photoreceptor, an electrostatic latent image of an image to be transferred and develops the image by causing charged particles to adhere to the electrostatic latent image on the photoreceptor. As the development devices 110, existing devices used in an electrophotographic image forming apparatus can be used. FIG. 2 shows a configuration example related to a case where a color image forming process, in which four colors including black in addition to three colors of yellow, magenta, and cyan are used, is performed. The development device 110 is provided for each of these colors and in FIG. 2, the development devices 110 for yellow, magenta, cyan, and black are respectively shown with letters “Y”, “M”, “C”, and “K” added thereto, the letters representing the colors corresponding to the development devices 110. In the following description, the description will be made with the letters “Y”, “M”, “C”, and “K” added to reference numerals in a case where the colors are to be distinguished therebetween regarding the development devices 110. However, in a case where the colors do not need to be distinguished therebetween, the description will be made without the letters added thereto.

The primary transfer rolls 120 are units used to transfer (primary transfer) images formed at the development devices 110 to the intermediate transfer belt 131. The primary transfer rolls 120 are disposed to face the photoreceptors of the development devices 110, and are configured such that the intermediate transfer belt 131 is positioned between the development devices 110 and the primary transfer rolls 120. The primary transfer rolls 120 are provided to respectively correspond to the development devices 110Y, 110M, 110C, and 110K. In FIG. 2, the primary transfer rolls 120 corresponding to the development devices 110Y, 110M, 110C, and 110K for the respective colors are respectively shown with letters “Y”, “M”, “C”, and “K” added thereto, the letters representing the colors corresponding to the primary transfer rolls 120. In the following description, the description will be made with the letters “Y”, “M”, “C”, and “K” added to reference numerals in a case where the colors are to be distinguished therebetween regarding the primary transfer rolls 120. However, in a case where the colors do not need to be distinguished therebetween, the description will be made without the letters added thereto.

The intermediate transfer belt 131, the rollers 132 and 133, and the backup roll 140 are units used to transfer the image formed at the development devices 110 to the medium 500. As shown in FIG. 2, the intermediate transfer belt 131 rotates in a direction along arrows in FIG. 2 (a counterclockwise direction in an example shown in the drawing) in a state of being hung on the rollers 132 and 133 and the backup roll 140 and stretched. The direction of the above-described rotation is a direction that coincides with, at a “transfer position” which will be described later, a transport direction in which the medium 500 is transported by the transport mechanism 400. The rotation of the intermediate transfer belt 131 is performed, for example, by using one or both of the rollers 132 and 133 as rotationally driving rollers and pulling the intermediate transfer belt 131 by means of rotation of the rollers.

In the configuration example of FIG. 2, an outer surface of the intermediate transfer belt 131 is a surface (hereinafter, referred to as a “transfer surface”) at which an image is held. In a case where the intermediate transfer belt 131 passes through a space between the development devices 110 and the primary transfer rolls 120, images are transferred from the photoreceptors of the development devices 110 to the transfer surface of the intermediate transfer belt 131. In the configuration example shown in FIG. 2, a yellow (Y) image, a magenta (M) image, a cyan (C) image, and a black (K) image are superimposed on the transfer surface by the development devices 110Y, 110M, 110C, and 110K and the primary transfer rolls 120Y, 120M, 120C, and 120K, so that a multicolor image is formed.

The backup roll 140 brings the transfer surface of the intermediate transfer belt 131 into contact with the medium 500 so that the image is transferred to the medium (secondary transfer). The backup roll 140 is an example of a transfer roller. A predetermined voltage is applied to the backup roll 140 in a case where the image is to be transferred. Accordingly, an electric field (hereinafter, referred to as a “transfer electric field”) is generated in an area including the backup roll 140 and the medium 500, and an image formed by charged particles is transferred from the intermediate transfer belt 131 to the medium 500. For transfer of an image from the intermediate transfer belt 131 to the medium 500 as described above, a current needs to flow from the backup roll 140 to the medium 500 via the intermediate transfer belt 131. Here, in a case where the medium 500 is a conductor such as metal, the image is transferred to a surface of the medium 500 as a transfer electric field is generated since a current flows through the medium 500 itself. Meanwhile, in a case where the medium 500 is not a conductor, the image cannot be transferred as it is because no current flows through the medium. Therefore, in a case where a material that is not a conductor is used as the medium 500, a layer formed of a conductive material (hereinafter, referred to as a “conductive layer”) is formed or the like at least on an image formation target region of a surface of the medium 500 in advance so that a current flows through the medium 500.

A procedure for image transfer performed by means of the intermediate transfer belt 131 will be described. In a case where the intermediate transfer belt 131 is rotated, a yellow (Y) image, a magenta (M) image, a cyan (C) image, and a black (K) image are sequentially superimposed on the transfer surface (the outer surface in FIG. 2) of the intermediate transfer belt 131 by the development devices 110Y, 110M, 110C, and 110K and the primary transfer rolls 120Y, 120M, 120C, and 120K, so that a multicolor image is formed. In a case where the intermediate transfer belt 131 is further rotated, the image formed on the transfer surface of the intermediate transfer belt 131 reaches a position where the intermediate transfer belt 131 comes into contact with the medium 500 (hereinafter, referred to as the “transfer position”). Then, as described above, a voltage is applied to the backup roll 140 so that a transfer electric field is generated and the image is transferred from the intermediate transfer belt 131 to the medium 500.

The cleaning device 150 is a unit that removes particles adhering to the transfer surface of the intermediate transfer belt 131. The cleaning device 150 is provided downstream of the transfer position and is provided upstream of the development device 110Y and the primary transfer roll 120Y in the direction of rotation of the intermediate transfer belt 131. Accordingly, particles remaining on the transfer surface of the intermediate transfer belt 131 are removed by the cleaning device 150 after an image is transferred from the intermediate transfer belt 131 to the medium 500. Then, in the next operation cycle, an image is newly transferred (primary transfer) to the transfer surface from which the particles have been removed.

### Configuration of Transport Mechanism 400 and Attachment Structure for Medium 500

Here, an attachment structure for the medium 500 will be described. The present exemplary embodiment is based on the assumption that the mediums 500 having various thicknesses and shapes are used. In a case where the mediums 500 are transported after being directly placed on a transport path composed of a belt or a roller and the mediums 500 have different thicknesses or shapes, it is difficult to appropriately bring the intermediate transfer belt 131 into contact with the mediums 500 since the heights of the mediums 500 with respect to the transport path are different from each other at the transfer position of the transfer unit 100. Specifically, the medium 500 does not come into contact with the intermediate transfer belt 131 in a case where the height of the medium 500 is small and a strong impact may occur in the case of contact between the medium 500 and the intermediate transfer belt 131 in a case where the height of the medium 500 is large. Therefore, in the case of the transport mechanism 400 of the present exemplary embodiment, the medium 500 is placed on the attachment table 420 including height control means and the medium 500 is transported together with the attachment table 420.

Referring to FIG. 2, the transport mechanism 400 includes the transport rail 410 that specifies a transport route of the medium 500 and the attachment table 420 that moves on the transport rail 410. The attachment table 420 includes a leg portion 421 attached to the transport rail 410 and a pedestal portion 422 on which the medium 500 is placed. In addition, a jig 423 that holds the medium 500 on the pedestal portion 422 is attached to the pedestal portion 422. The transport mechanism 400 is an example of a transport unit. The attachment table 420 is an example of a holding portion.

In a configuration example shown in FIG. 1, the transport rail 410 is installed across an area from the medium attachment and detachment unit 300 to the transfer unit 100 with the fixation unit 200 interposed therebetween. An end portion of the transport rail 410 that is on the medium attachment and detachment unit 300 side is the transport start position and is the transport end position. The attachment table 420 is transported leftward in FIG. 1 from the transport start position of the medium attachment and detachment unit 300, and an image is transferred to the medium 500 in the transfer unit 100. The attachment table 420 is transported to rightward in FIG. 1 after the transfer of the image, and the attachment table 420 reaches the transport end position of the medium attachment and detachment unit 300 after the image is fixed to the medium 500 at the fixation unit 200.

The leg portion 421 is attached to the transport rail 410 and moves on the transport rail 410. A mechanism for movement of the leg portion 421 on the transport rail 410 is not particularly limited. For example, the leg portion 421 may be configured to automatically travel while being provided with a driving device or the transport rail 410 may be provided with a means for pulling the leg portion 421.

In addition, the leg portion 421 includes a lifting and lowering unit 421a as height control means for controlling the height of the pedestal portion 422. The lifting and lowering unit 421a controls the height of the pedestal portion 422 such that the medium 500 comes into contact with the intermediate transfer belt 131 in a case where an image is to be transferred to the medium 500 by means of the intermediate transfer belt 131 and the medium 500 is separated from the intermediate transfer belt 131 after the transfer is finished.

The configuration of the lifting and lowering unit 421a is not particularly limited. For example, the pedestal portion 422 may be moved upward and downward by a rack-and-pinion and a drive motor. In addition, the height of the pedestal portion 422 may be controlled by manually operating a gear linked to the height of the pedestal portion 422. Furthermore, various methods can be used as an operation method for height control. For example, an input interface for the control unit of the drive motor may be prepared, and an operator of the image forming apparatus 10 may manually input and set height data using the input interface. In addition, a configuration in which the height of the medium 500 attached to the attachment table 420 is automatically detected by means of a sensor and the drive motor is controlled such that the height of the medium 500 becomes an appropriate height may also be adopted.

The pedestal portion 422 is a pedestal that is attached to the leg portion 421 and on which the medium 500 is placed via the jig 423. The pedestal portion 422 is provided with a fastener (not shown) positioning the jig 423. Regardless of the shape of the jig 423 itself, the jig 423 can be positioned and attached to the pedestal portion 422 as long as the jig 423 matches the fastener.

In addition, the pedestal portion 422 is attached to move upward and downward with respect to the leg portion 421 in response to a pressure from above. A configuration in which the pedestal portion 422 moves upward and downward is realize with, for example, an elastic body interposed between junction portions of the pedestal portion 422 and the leg portion 421. With such a configuration, an impact in the case of contact between the medium 500 held by the jig 423 attached to the pedestal portion 422 and the intermediate transfer belt 131 of the transfer unit 100 is alleviated.

The jig 423 is a tool that holds the medium 500 and that is attached to the pedestal portion 422. A portion of the jig 423 that is attached to the pedestal portion 422 has a shape or a structure matching the fastener of the pedestal portion 422. In addition, the jig 423 has a shape for holding the medium 500. Therefore, it is possible to place the mediums 500 having various shapes or sizes on the attachment table 420 in a case where the jigs 423 matching the shapes or sizes of the mediums 500 are prepared. The present exemplary embodiment is based on the assumption that the medium 500 on which an image is formed is the medium 500 including a circumferential surface, and the image is transferred to the circumferential surface of the medium 500 along a circumferential direction by the transfer unit 100. Therefore, as the jig 423, a jig having a function of bringing the circumferential surface of the medium 500 into contact with the intermediate transfer belt 131 of the transfer unit 100 along the circumferential direction is used. Details of the jig 423 as described above will be described later.

### Configuration of Fixation Unit 200

In a case where an image is transferred to the medium 500 in the transfer unit 100, the image is fixed at the fixation unit 200 thereafter. In the present exemplary embodiment, for example, a fixation process is performed by a non-contact type device so that images are formed on the mediums 500 having various thicknesses and shapes. The fixation unit 200 heats and melts particles forming the image transferred to the medium 500 to fix the particles to a surface of the medium 500.

The fixation unit 200 includes a heat source for thermal fixation. As the heat source, for example, various existing heat sources such as a halogen lamp, a ceramic heater, and an infrared lamp may be used. In addition, instead of the heat source, a device that heats the particles forming the image by irradiating the particles with an infrared laser may also be used. The fixation unit 200 may have a configuration in which a covering member that can cover the heat source is provided and the heat source is exposed in the case of the fixation process. The covering member is realized by, for example, a shutter or an opening and closing door. In addition, a configuration in which leakage of internal air is prevented by means of a curtain formed of a heat insulating material or an air curtain may also be adopted.

### Preliminary Operation for Image Formation

Since the image forming apparatus 10 of the present exemplary embodiment includes the transport mechanism 400 configured as described above, printing can be performed on the mediums 500 having various shapes and sizes. However, the height of the pedestal portion 422 is controlled before an image transfer operation is started in order to prevent a problem in which a strong impact is caused because of contact between the medium 500 and the intermediate transfer belt 131 of the transfer unit 100 in the case of transfer of an image to the medium 500 or the medium 500 and the intermediate transfer belt 131 do not come into contact with each other.

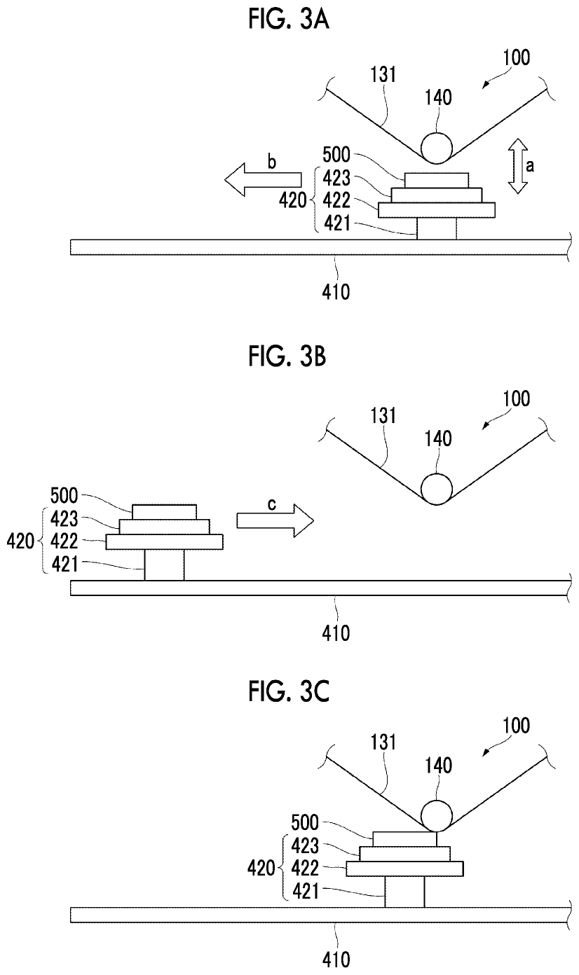

FIGS. 3A to 3C are views showing an operation of the transport mechanism 400 before image formation performed by the transfer unit 100 is started. FIG. 3A is a view showing a state where the height control is performed, FIG. 3B is a view showing a state where the transport mechanism 400 has been withdrawn to a preparation position after the height control, and FIG. 3C is a view showing a state where transfer of an image is started by the transfer unit 100.

In a case where an image is to be formed on the medium 500, first, the medium 500 held by the jig 423 is set on the attachment table 420 at the transport start position of the medium attachment and detachment unit 300. Then, after the medium 500 is lowered by the lifting and lowering unit 421a of the attachment table 420 to a height at which the medium 500 does not come into contact with the intermediate transfer belt 131 of the transfer unit 100, the attachment table 420 with the medium 500 placed thereon moves to a position below the transfer position of the transfer unit 100.

Next, the height of the attachment table 420 is controlled such that the medium 500 is brought into contact with the intermediate transfer belt 131 at the transfer position at an intensity appropriate for image transfer (arrow a in FIG. 3A). In a case where the height control is performed, information about an obtained appropriate height (hereinafter, referred to as a “transfer execution height”) is held in a memory or the like of the control unit. Then, the attachment table 420 is lowered to a height at which the medium 500 does not come into contact with the intermediate transfer belt 131 and moves to a transfer operation preparation position (arrow b in FIG. 3A).

In a case where the attachment table 420 moves to the preparation position, the height of the attachment table 420 is adjusted to the transfer execution height based on the information obtained in the height control. Thereafter, the attachment table 420 moves to the transfer position (arrow c in FIG. 3B) and image transfer is started in a case where the medium 500 comes into contact with the intermediate transfer belt 131 at the transfer position (FIG. 3C).

### Transfer of Image to Medium 500 Including Circumferential Surface

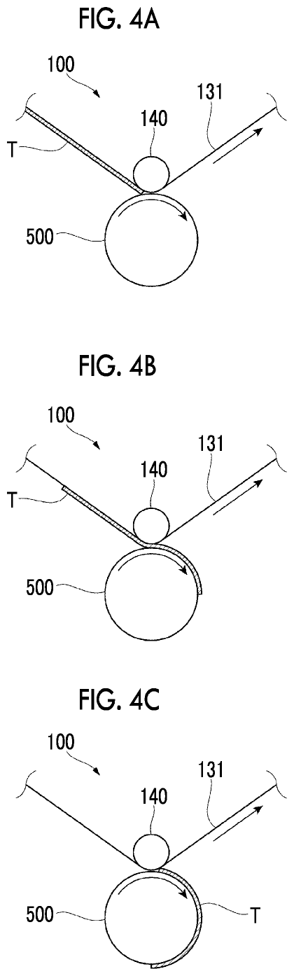

FIGS. 4A to 4C are views showing a method of transferring an image to the medium 500 including a circumferential surface. FIG. 4A is a view showing a state at the start of transfer, FIG. 4B is a view showing a state during the transfer, and FIG. 4C is a view showing a state at the end of the transfer. In an example shown in FIGS. 4A to 4C, a state where an image T is transferred to a side surface of the medium 500 over half of a circumference in a circumferential direction, the medium 500 having a columnar shape.

In a case where the image T is to be formed on the side surface of the medium 500, which is the circumferential surface, along the circumferential direction, a portion of the side surface of the medium 500 that comes into contact with the intermediate transfer belt 131 of the transfer unit 100 needs to move in accordance with advance of the intermediate transfer belt 131 in a state where the medium 500 is stopped at the transfer position of the transfer unit 100. Therefore, the jig 423 holds the medium 500 such that a central axis of the circumferential surface of the medium 500 is orthogonal to an advance direction (hereinafter, referred to as a “transfer direction”) of the intermediate transfer belt 131 at the transfer position, and the medium 500 is rotated around the central axis. The direction of rotation of the medium 500 is a direction in which advance of the circumferential surface coincides with the transfer direction of the intermediate transfer belt 131 at a position at which the intermediate transfer belt 131 and the circumferential surface of the medium 500 come into contact with each other. In an example shown in FIGS. 4A to 4C, the medium 500 is shown with the central axis of the circumferential surface extending in a direction perpendicular to the paper surface. In addition, the intermediate transfer belt 131 advances from a left side to a right side in the drawing and the medium 500 rotates clockwise in the drawing (refer to an arrow in the drawing).

In a case where the transfer unit 100 transfer the image T to the medium 500, first, the image T is formed on the intermediate transfer belt 131 by the development devices 110 of the respective colors as the intermediate transfer belt 131 advances. In addition, in a case where the intermediate transfer belt 131 further advances and the image T formed on the intermediate transfer belt 131 reaches the transfer position, the image T is transferred to the medium 500 from the intermediate transfer belt 131 as shown in FIG. 4A. In a case where the intermediate transfer belt 131 further advances, the medium 500 rotates and transfer of the image T is performed with a contact portion of the medium 500 moving along the circumferential direction. Therefore, as shown in FIGS. 4B and 4C, the image T on the intermediate transfer belt 131 is transferred to the circumferential surface of the medium 500 along the circumferential direction.

### Configuration of Jig 423

Next, the jig 423 for the medium 500 including a circumferential surface will be described. In the present exemplary embodiment, as described with reference to FIGS. 4A to 4C, the jig 423 that rotates the medium 500 to continuously bring the circumferential surface of the medium 500 into contact with the intermediate transfer belt 131 of the transfer unit 100 along the circumferential direction is used. Hereinafter, the configuration of such a jig 423 will be described with reference to a specific example.

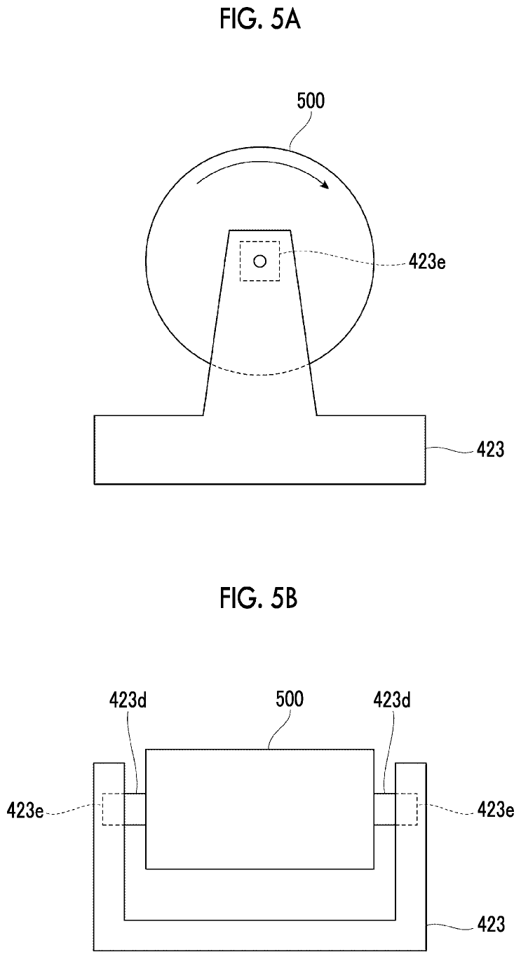

FIGS. 5A and 5B are views showing a configuration example of the jig 423 that rotatably holds the medium 500, FIG. 5A is a view of the jig 423 and the medium 500 as seen in a direction parallel to the rotation axis of the medium 500, and FIG. 5B is a view of the jig 423 and the medium 500 as seen in a direction perpendicular to the rotation axis of the medium 500. The jig 423 shown in FIGS. 5A and 5B supports the medium 500 such that the medium 500 can rotate with the central axis of the circumferential surface as the rotation axis. The jig 423 includes retaining tools 423d that rotatably retains the medium 500. A driving device 423e for rotation of the medium 500 is built into the jig 423. The jig 423 has a structure that matches the fastener of the pedestal portion 422 and is fixed to the pedestal portion 422.

The jig 423 shown in FIGS. 5A and 5B retains the medium 500 with the retaining tools 423d sandwiching, from both of axial end sides, a position through which the central axis of the circumferential surface of the medium 500 extends. The driving device 423e is driving means for rotating the retaining tools 423d. The retaining tools 423d obtain power from the driving device 423e in a state of retaining the medium 500 and rotates the medium 500 around the central axis of the circumferential surface. As the driving device 423e, various existing mechanisms can be used and the structure thereof is not limited specifically. For example, the retaining tools 423d may be directly rotationally driven by a motor. The driving device 423e rotates the retaining tools 423d such that the speed of rotation of the medium 500 is made equal to the speed of advance of the intermediate transfer belt 131 at the position of contact between the medium 500 and the intermediate transfer belt 131 of the transfer unit 100.

Here, a configuration, in which the jig 423 is provided with the driving device 423e and the jig 423 dynamically rotates the medium 500 in accordance with the operation of the intermediate transfer belt 131 of the transfer unit 100 with the retaining tools 423d used as drive wheels, has been described. However, the jig 423 may have a configuration in which the jig 423 simply rotatably supports the medium 500 and the medium 500 rotates in accordance with the motion of the intermediate transfer belt 131 with the retaining tools 423d used as driven wheels. For example, in a case where the medium 500 is formed of a material having a friction coefficient larger than the friction coefficient of the intermediate transfer belt 131, the medium 500 is pulled by the intermediate transfer belt 131 at the position of contact and rotates even without being driven by the retaining tools 423d.

Since the jig 423 shown in FIGS. 5A and 5B rotates the medium 500 while retaining the central axis of the circumferential surface of the medium 500, the mediums 500 that have the circumferential surfaces and that have various shapes such as a spherical shape and a conical shape can be held with the central axes of the circumferential surface retained. In addition, the jig 423 shown in FIGS. 5A and 5B can hold the medium 500 such that an image is transferred to a portion of the circumferential surface even in a case where there is an uneven portion on the circumferential surface of the medium 500.

### Movement Control of Medium 500 at Transfer Position

In a case where an image is to be transferred to the circumferential surface of the medium 500 at the transfer unit 100, as described above, the medium 500 itself needs to be stopped at the transfer position during the image transfer while the medium 500 is rotating in accordance with advance of the intermediate transfer belt 131 of the transfer unit 100. As a method of stopping the movement of the medium 500 during the image transfer, a method, in which the transport mechanism 400 stops transportation of the attachment table 420 with the medium 500 placed thereon in a case where the medium 500 reaches the transfer position, is conceivable, for example. In addition, as another method, a method, in which the jig 423 is moved with relative to the pedestal portion 422 of the attachment table 420 in a direction opposite to a transport direction of the attachment table 420 so that the position of the medium 500 is stopped relative to the transfer position of the transfer unit 100, is conceivable.

In the configuration described with reference to FIG. 2, the jig 423 is fixed to the attachment table 420 by means of the fastener provided at the pedestal portion 422. Meanwhile, in a case where the jig 423 is moved relative to the pedestal portion 422, the pedestal portion 422 is provided with a movement path and the jig 423 includes moving means for movement along the movement path. Specific configurations of the movement path of the pedestal portion 422 and the moving means of the jig 423 are not particularly limited as long as the jig 423 can move along the determined movement path. For example, a configuration in which the pedestal portion 422 is provided with a groove or a rail as the movement path and the jig 423 includes wheels used to travel along the groove or the rail as the moving means is conceivable. More specifically, with a rack-and-pinion in which a rack is used as a rail of the movement path and a pinion gear is used as a wheel of the jig 423, rotation of the pinion gear of the jig 423 may be controlled to move the jig 423. The movement of the jig 423 may be realized by a configuration in which the jig 423 includes driving means such as a motor and the jig 423 automatically travels on the movement path of the pedestal portion 422. In addition, the movement path of the pedestal portion 422 may be provided with means for pulling the jig 423.

The movement path is provided to be parallel to the transport direction of the attachment table 420. The jig 423 can move only in a direction along the movement path is restricted from moving in a width direction of the movement path. In addition, in a case where the jig 423 is moved relative to the pedestal portion 422, the movement path needs to have a length enough for the jig 423 to move during transfer of an image to the medium 500. Therefore, the size of the pedestal portion 422 with respect to the jig 423 is large in comparison with a configuration in which the jig 423 is fixed to the pedestal portion 422 as in the configuration described with reference to FIG. 2.

### Transfer Position

Next, the transfer position will be described. Since the jig 423 configured as described with reference to FIGS. 5A and 5B is used, an image can be formed on the circumferential surface of the medium 500 with the medium 500 rotating once (360 degrees) or more. However, at a stage where the image is formed in the transfer unit 100, a step of fixing the image by the fixation unit 200 has not been performed and thus the image formed on the medium 500 has not been fixed. For this reason, distortion of the image formed on the medium 500 occurs in a case where the medium 500 rotates and a portion on which the image has been formed already comes into contact with the intermediate transfer belt 131 again.

In the present exemplary embodiment, the transfer position is set and thus the medium 500 is separated from the intermediate transfer belt 131 without a portion, on which an image has been formed, coming into contact with the intermediate transfer belt 131 again after the image is formed on the medium 500. Note that there is a case where the medium 500 is rotated once (360 degrees) or more so that an image is formed (overwritten) on a portion on which an image has been formed already. In such a case, there is no image distortion since a transfer electric field is applied to the medium 500 during image transfer at the transfer position. The present exemplary embodiment is applied even to a case where an image is to be transferred over the circumference of the circumferential surface of the medium 500 once or more, and the medium 500 is restrained from coming into contact with the intermediate transfer belt 131 again after image formation at the transfer position is finished.

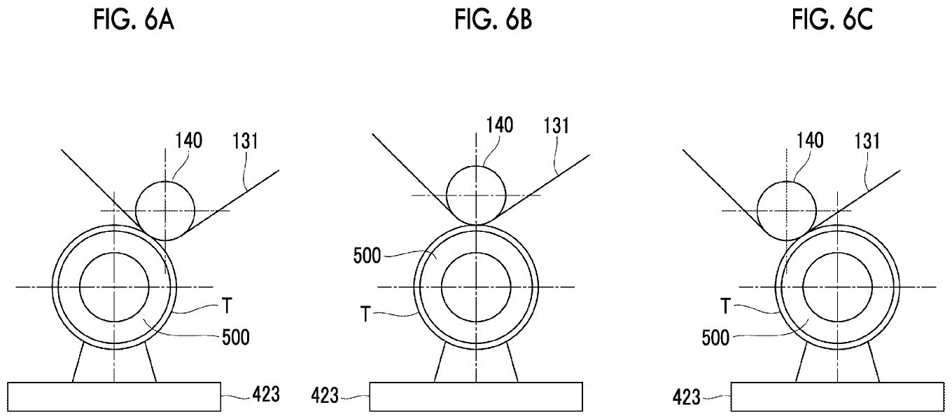

FIGS. 6A to 6C are views showing an example of the transfer position, FIG. 6A is a view showing a state where the transfer position is set upstream of a lowermost end of the intermediate transfer belt 131, FIG. 6B is a view showing a state where the transfer position is set at the lowermost end of the intermediate transfer belt 131, and FIG. 6C is a view showing a state where the transfer position is set downstream of the lowermost end of the intermediate transfer belt 131. In each of FIGS. 6A to 6C, the medium 500 is transported from the left side of the drawing and is transported to the right side of the drawing after image transfer. In addition, in the example shown in FIGS. 6A to 6C, the image T is formed on the entire circumferential surface of the medium 500. Note that in FIGS. 6A to 6C, the jig 423 is partially omitted in order to make it easy to understand the positional relationship between the medium 500 and the transfer position.

Here, the “lowermost end” of the intermediate transfer belt 131 is a most downwardly projecting portion of the intermediate transfer belt 131 in a state of being hung on the rollers 132 and 133 and the backup roll 140 and stretched in the configuration of the transfer unit 100 described with reference to FIG. 2. In the case of the transfer unit 100 shown in FIG. 2, the backup roll 140 is positioned at the lowest position among the plurality of rollers stretching the intermediate transfer belt 131 and the lowermost end is present at a portion hung on the backup roll 140. Since the intermediate transfer belt 131 rotates in a state of being hung on the rollers, a lowermost end portion of the intermediate transfer belt 131 is a portion positioned at the lowermost end at each time point and moves rearward in the direction of rotation as the intermediate transfer belt 131 rotates. In addition, an “upstream side” and a “downstream side” with respect to the lowermost end are an upstream side and a downstream side in the direction of rotation of the intermediate transfer belt 131.

In a case where the transfer position is set upstream of the lowermost end of the intermediate transfer belt 131 as shown in FIG. 6A, the lowermost end of the intermediate transfer belt 131 is present on a side to which transportation is performed after image transfer. Therefore, after the image T is formed, the medium 500 is transported across the lowermost end of the intermediate transfer belt 131. Therefore, a portion of the medium 500 on which the image T has been formed may come into contact with the intermediate transfer belt 131 in a case where the medium 500 moves across the lowermost end of the intermediate transfer belt 131.

In a case where the transfer position is set at the lowermost end of the intermediate transfer belt 131 as shown in FIG. 6B and transportation of the medium 500 is restarted after formation of the image T is finished, the medium 500 is immediately separated from the intermediate transfer belt 131. Therefore, there is no possibility that a portion on which the image T has been formed comes into contact with the intermediate transfer belt 131 again.

Even in a case where the transfer position is set downstream of the lowermost end of the intermediate transfer belt 131 as shown in FIG. 6C and transportation of the medium 500 is restarted after formation of the image T is finished, the medium 500 is immediately separated from the intermediate transfer belt 131. Therefore, there is no possibility that a portion on which the image T has been formed comes into contact with the intermediate transfer belt 131 again.

As described above, to restrain the medium 500 from coming into contact with the intermediate transfer belt 131 again after formation of the image T is finished at the transfer position, the transfer position is set at the lowermost end of the intermediate transfer belt 131 or set downstream of the lowermost end of the intermediate transfer belt 131. Note that although the transfer position is set at the lowermost end of the intermediate transfer belt 131 or set downstream of the lowermost end of the intermediate transfer belt 131 herein with reference to the configuration of the transfer unit 100 shown in FIG. 2, the transfer position may be set to a different position depending on the configuration of the transfer unit 100. Specifically, in the configuration of the transfer unit 100, the transfer position is set at a position at which the intermediate transfer belt 131 is caused by the backup roll 140 to project to the medium 500 side most or set downstream of such a position.

In a case where the transfer position is set to a position other than the lowermost end of the intermediate transfer belt 131, the medium 500 moves across the lowermost end of the intermediate transfer belt 131 while the medium 500 is being transported. At this time, the attachment table 420 adjusts the height of the medium 500 such that the medium 500 is lowered corresponding to the amount of vertical movement of the medium 500 moving across the lowermost end of the intermediate transfer belt 131. A configuration for adjustment of the height of the medium 500 will be described.

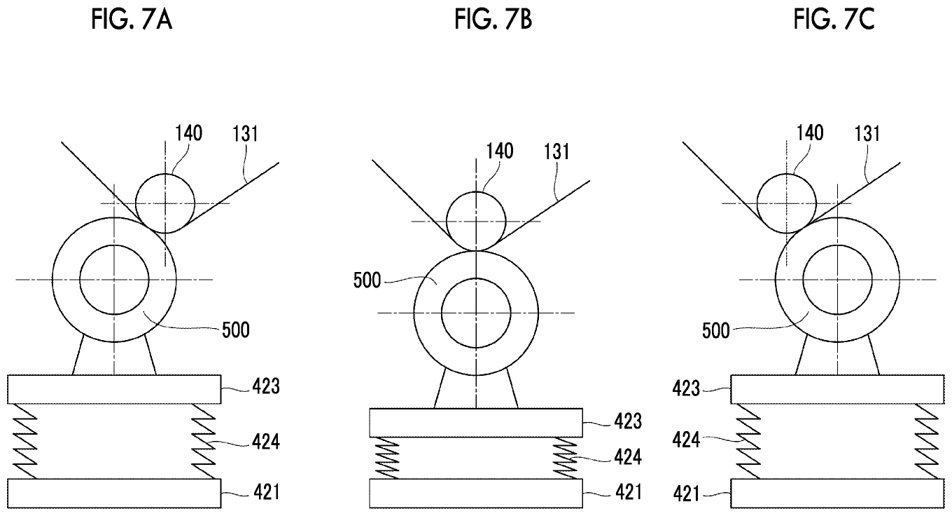

FIGS. 7A to 7C are views showing an example of a height adjustment method for the medium 500, FIG. 7A is a view showing a state where the medium 500 is in contact with the lowermost end of the intermediate transfer belt 131 while being positioned upstream of the lowermost end, FIG. 7B is a view showing a state where the medium 500 is in contact with the lowermost end of the intermediate transfer belt 131, and FIG. 7C is a view showing a state where the medium 500 is in contact with the lowermost end of the intermediate transfer belt 131 while being positioned downstream of the lowermost end. Note that in FIGS. 7A to 7C, the jig 423 is partially omitted in order to make it easy to understand the positional relationship between a position at which the medium 500 comes into contact with the intermediate transfer belt 131 and the medium 500.

In the example shown in FIGS. 7A to 7C, an elastic member 424 is provided between the jig 423 and the leg portion 421 of the attachment table 420. As the elastic member 424, for example, a compression spring is used. In a case where the medium 500 is transported, the elastic member 424 interposed between the jig 423 and the leg portion 421 is elastically deformed in accordance with a force by which the medium 500 in contact with the intermediate transfer belt 131 is pressed to a lower side from an upper side. Accordingly, the jig 423 moves downward so that the height of the medium 500 is lowered and the medium 500 moves across the lowermost end of the intermediate transfer belt 131.

### Prevention of Repetitive Contact Achieved by Other Realization Means

In the present exemplary embodiment, the medium 500 is separated from the intermediate transfer belt 131 without a portion, on which an image has been formed, coming into contact with the intermediate transfer belt 131 again after the image is formed on the medium 500. In addition, in the example described with reference to FIGS. 6A to 6C, the transfer position is set and thus the medium 500 on which an image has been formed and the intermediate transfer belt 131 are restrained from coming into contact with each other again. Here, the medium 500 on which an image has been formed and the intermediate transfer belt 131 may be restrained from coming into contact with each other again without the setting of the transfer position. For example, a method, in which the medium 500 on which an image has been formed and the intermediate transfer belt 131 are restrained from coming into contact with each other again by means of the transport direction of the medium 500, is conceivable.

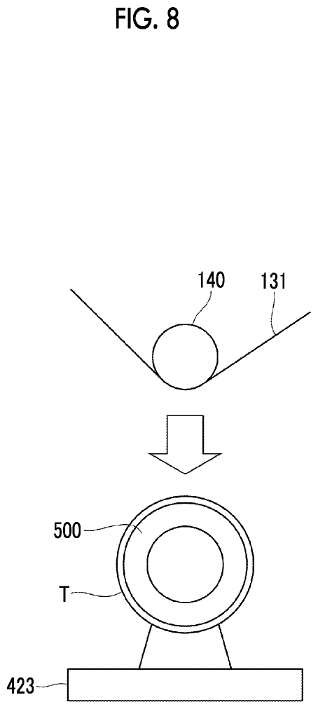

FIG. 8 is a view showing an example in which the medium 500 and the intermediate transfer belt 131 are restrained from coming into contact with each other again by means of the transport direction. In the example shown in FIG. 8, a transport direction after image transfer to the medium 500 is a direction toward a lower side of the drawing (refer to an arrow in the drawing). According to such a configuration, in any of a case (refer to FIG. 6A) where the transfer position is set upstream of the lowermost end of the intermediate transfer belt 131, a case (refer to FIG. 6B) where the transfer position is set at the lowermost end of the intermediate transfer belt 131, and a case (refer to FIG. 6C) where the transfer position is set downstream of the lowermost end of the intermediate transfer belt 131, the medium 500 is immediately separated from the intermediate transfer belt 131 without a portion, on which the image T has been formed, coming into contact with the intermediate transfer belt 131 again as transportation of the medium 500 is restarted after formation of the image T is finished.

Note that the transport direction before image transfer is not particularly limited. For example, a configuration in which the medium 500 is transported to move upward from a lower side before transfer and come into contact with the intermediate transfer belt 131 at the transfer position and the medium 500 is transported to the lower side after the image transfer may also be adopted. In addition, a configuration, in which the medium 500 is transported from the left side of the drawing before transfer, comes into contact with the intermediate transfer belt 131 at the transfer position, and is transported to the lower side after the image transfer as described with reference to FIGS. 4A to 4C and FIGS. 6A to 6C, may also be adopted.

In addition, as another example in which the medium 500 on which an image has been formed and the intermediate transfer belt 131 are restrained from coming into contact with each other again without the setting of the transfer position, there is an example in which the operation of the lifting and lowering unit 421a provided at the leg portion 421 of the attachment table 420 is used. The lifting and lowering unit 421a controls the height of the medium 500 by lifting and lowering the pedestal portion 422 of the attachment table 420. Therefore, a method, in which the medium 500 is lowered by the lifting and lowering unit 421a after an image is formed on the medium 500 so that the medium 500 is separated from the intermediate transfer belt 131 and transportation of the medium 500 is restarted, is conceivable.

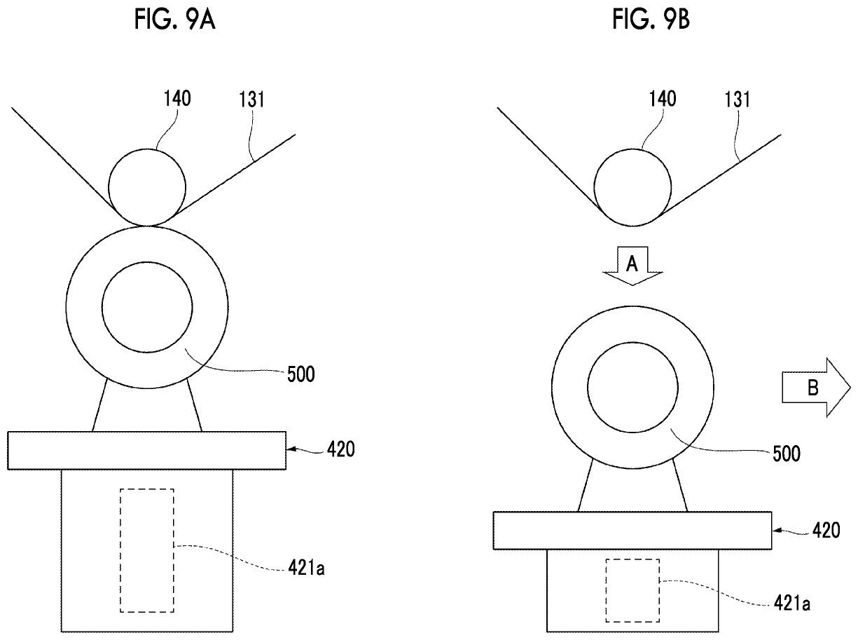

FIGS. 9A and 9B are views showing an example in which the lifting and lowering unit 421a restrains the intermediate transfer belt 131 and the medium 500 from coming into contact with each other again, FIG. 9A is a view showing a state where the intermediate transfer belt 131 and the medium 500 are in contact with each other, and FIG. 9B is a view showing a state where the intermediate transfer belt 131 and the medium 500 are separated from each other. As shown in FIG. 9A, at the time of image transfer, the lifting and lowering unit 421a controls the height of the medium 500 such that the height reaches the transfer execution height set in the preliminary operation described with reference to FIGS. 3A to 3C. Then, after an image is formed on the medium 500, as shown in FIG. 9B, the lifting and lowering unit 421a lowers the height of the medium 500 so that the medium 500 is separated from the intermediate transfer belt 131 (refer to arrow A in the drawing) and the transport mechanism 400 restarts transportation of the medium 500 after the image transfer (refer to arrow B in the drawing).

Although the exemplary embodiment of the present invention has been described above, the technical scope of the exemplary embodiment of the present invention is not limited to the above exemplary embodiment. For example, in the above-described exemplary embodiment, the jig 423 is configured to retain the medium 500 by sandwiching, from both of axial end sides, a position through which the central axis of the circumferential surface of the medium 500 extends. However, the configuration of the jig 423 is not limited to a configuration as in the above-described exemplary embodiment as long as the jig 423 rotatably holds the medium 500 without coming into contact with a portion of the medium 500 on which an image is formed. In addition, various modifications and alternative configurations are involved in the present invention without departing from the technical scope of the present invention.

### Supplementary Note

((((1))))

An image forming apparatus comprising:
a transfer unit that comes into contact with a target object and that transfers an image to the target object;
a holding portion that holds the target object including a circumferential surface such that the circumferential surface rotates along a transfer direction of the transfer unit; and
a transport unit that transports the target object held by the holding portion along a transport route, that stops transportation of the target object in a case where the transfer unit transfers the image to the target object, and that causes the target object to be separated from the transfer unit before a surface of the target object on which transfer of the image is finished comes into contact with the transfer unit again.
   ((((2))))

The image forming apparatus according to (((1))))
wherein the transfer unit includes
   a belt that is hung on a plurality of rollers and stretched, that holds an image formed by means of charged particles, that rotates to move in a direction coinciding with a transport direction of the target object at a transfer position, and that transfers the image to the target object at the transfer position, and
   a transfer roller that is one of the plurality of rollers and that is disposed such that the belt projects to a target object side, and
the transfer position is positioned at a position at which the belt is caused by the transfer roller to project to the target object side most or is positioned downstream of the position in an operation direction of the belt.
   (((((3))))

The image forming apparatus according to (((2))), further comprising:
a height adjustment unit that adjusts a height of the target object held by the holding portion in accordance with a position of contact between the belt and the target object.
   ((((4))

The image forming apparatus according to any one of (((1))) to (((3))),
wherein the transport route of the transport unit is a route along which the target object moves in a direction away from a position of contact with the transfer unit after the transfer unit transfers the image to the target object.
   ((((5))))

The image forming apparatus according to any one of (((1))) to (((4))), further comprising:
a lifting and lowering unit that changes a height of the target object held by the holding portion and that lowers the height of the target object so that the target object is separated from the transfer unit after the transfer unit transfers the image to the target object.
   (((((6))))

The image forming apparatus according to (((5))),
wherein the transfer unit includes
   a belt that is hung on a plurality of rollers and stretched, that holds an image formed by means of charged particles, that rotates to move in a direction coinciding with a transport direction of the target object at a transfer position, and that transfers the image to the target object at the transfer position, and
   a transfer roller that is one of the plurality of rollers and that is disposed such that the belt projects to a target object side, and
in a case where the transfer position is positioned downstream of a position at which the belt projects to the target object side most, the lifting and lowering unit lowers the height of the target object to be lower than the position at which the belt projects most and increases the height of the target object so that the target object comes into contact with the belt after the transport unit passes through the position at which the belt projects most.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a transfer unit that comes into contact with a target object and that transfers an image to the target object;
a holding portion that holds the target object including a circumferential surface such that the circumferential surface rotates along a transfer direction of the transfer unit; and
a transport unit that transports the target object held by the holding portion along a transport route, that stops transportation of the target object in a case where the transfer unit transfers the image to the target object, and that causes the target object to be separated from the transfer unit before a surface of the target object on which transfer of the image is finished comes into contact with the transfer unit again.

2. The image forming apparatus according to claim 1,
wherein the transfer unit includes
a belt that is hung on a plurality of rollers and stretched, that holds an image formed by means of charged particles, that rotates to move in a direction coinciding with a transport direction of the target object at a transfer position, and that transfers the image to the target object at the transfer position, and
a transfer roller that is one of the plurality of rollers and that is disposed such that the belt projects to a target object side, and
the transfer position is positioned at a position at which the belt is caused by the transfer roller to project to the target object side most or is positioned downstream of the position in an operation direction of the belt.

3. The image forming apparatus according to claim 2, further comprising:
a height adjustment unit that adjusts a height of the target object held by the holding portion in accordance with a position of contact between the belt and the target object.

4. The image forming apparatus according to claim 1,
wherein the transport route of the transport unit is a route along which the target object moves in a direction away from a position of contact with the transfer unit after the transfer unit transfers the image to the target object.

5. The image forming apparatus according to claim 1, further comprising:
a lifting and lowering unit that changes a height of the target object held by the holding portion and that lowers the height of the target object so that the target object is separated from the transfer unit after the transfer unit transfers the image to the target object.

6. The image forming apparatus according to claim 5,
wherein the transfer unit includes
a belt that is hung on a plurality of rollers and stretched, that holds an image formed by means of charged particles, that rotates to move in a direction coinciding with a transport direction of the target object at a transfer position, and that transfers the image to the target object at the transfer position, and
a transfer roller that is one of the plurality of rollers and that is disposed such that the belt projects to a target object side, and
in a case where the transfer position is positioned downstream of a position at which the belt projects to the target object side most, the lifting and lowering unit lowers the height of the target object to be lower than the position at which the belt projects most and increases the height of the target object so that the target object comes into contact with the belt after the transport unit passes through the position at which the belt projects most.
